(19) United States
(12) Patent Application Publication
(10) Pub. No.: US 2018/0281638 A1
(43) Pub. Date: Oct. 4, 2018

(54) CAR SEAT HEADREST STRUCTURE WITH MULTIPART SUPPORTING EFFECT

(71) Applicant: ASIASONIC INTERNATIONAL INDUSTRIAL CO., LTD., New Taipei City (TW)

(72) Inventor: FA-YIU CHU, NEW TAIPEI CITY (TW)

(21) Appl. No.: 15/595,052

(22) Filed: May 15, 2017

(30) Foreign Application Priority Data
Mar. 31, 2017 (TW) 106204617

(51) Int. Cl. B60N 2/48; B60R 7/04

(52) U.S. Cl. CPC B60N 2/4882; B60N 2/4885; B60R 7/04; B60N 2/4876; B60N 2002/4888; B60N 2205/30; B60N 2/48

(57) ABSTRACT

A car seat headrest structure with multipart supporting effect includes a headrest main body and a support section. The main body is defined with a middle section, two lateral sections, an upper section and a lower section. The support section includes two lateral support sections positioned on the two lateral sections and a lower support section positioned on the lower section of the main body. The lower support section and the lateral support sections are flexible or elastic protrusion structures corresponding to the cervical vertebrae portion and the head of a user. The lateral support sections, the lower support section and the middle section of the main body together define an embracing/supporting section. In accordance with ergonomics, the support section can truly protect and support the head and the cervical vertebrae portion of the user according to the actual use requirements of the user.

### BACKGROUND OF THE INVENTION

### 1. Field of the Invention

The present invention relates generally to a car seat headrest structure with multipart supporting effect, and more particularly to a car seat headrest structure, which includes a headrest main body and a support section assembled with the main body. The support section has flexible protrusion structures corresponding to the cervical vertebrae portion and the head of a user. In accordance with ergonomics, the support section can truly protect and support the head and the cervical vertebrae portion of the user according to different use requirements of the user.

### 2. Description of the Related Art

A conventional car seat headrest is used to support the head of a user or a driver and relieve the loads of the neck and the spine and the tiredness of the user. The conventional car seat headrest structure is generally made of leather, fabric or plastic sheet and filling material enclosed therein. A link and a pivot assembly are disposed between the headrest and the car seat, whereby the headrest can be rotated to adjust the inclination angle so as to support the head of a user or a driver.

With respect to the structure and application of such kind of car seat headrest, in consideration of the manufacturing cost, the conventional car seat headrest is not manufactured according to the different head configurations or the use requirements possibly caused by the actual operation of the user. Therefore, the conventional car seat headrest structure can only provide basic supporting effect for the user. As a result, the conventional car seat headrest structure can hardly truly protect or fully support the head and the cervical vertebrae portion of the user.

As well known by those who are skilled in this field, the conventional car seat headrest structure only needs to provide basic supporting effect for the user. Therefore, in practice, a filling material with higher hardness is generally enclosed in the headrest so that even after a long period of use, the headrest still will not deform.

Especially, in use of the conventional headrest structure, the cervical vertebrae portion of the user (or the driver) hangs in the air without sufficient support. This fails to meet ergonomics. As a result, after a long period of use or driving, the cervical vertebrae portion of the user will feel sore to even affect the safety in driving.

In order to overcome the above shortcoming, an improved car seat headrest structure has been developed. The car seat headrest structure can be assembled with the car seat. In the headrest structure, two side pads are disposed on two sides of the headrest main body. The side pads can be orally inflated. An elastic tying strip is disposed on the back section of the headrest main body for fitting on the car seat so as to support and embrace the head of the user.

However, as well known by those who are skilled in this field, in actual use of the above headrest structure, the cervical vertebrae portion of the user still hangs in the air. This fails to meet the requirement of a user in a long-term driving. Moreover, the above headrest structure is only applicable to a structure module in which the back of the seat is higher, for example, the passenger seat of a large-size vehicle. Only in case of the higher seat back, the headrest main body can be disposed on the back of the seat at a height meeting the height of the head of the user sitting on the seat to provide supporting effect.

The structural form of the above headrest structure is inapplicable to the seat of an ordinary car, especially the driver seat. This is because in case the elastic tying strap of the headrest main body is fitted on the car seat, the height of the headrest main body cannot meet (lower than) the height of the head of the user or the driver sitting on the seat. This is unbeneficial to the user (or the driver). In case the elastic tying strap of the headrest main body is fitted on the headrest of the car seat, the overlapping thickness of the headrest main body and the car seat headrest will make the head of the user excessively forward tilt and the cervical vertebrae portion of the user will hang in the air to a larger extent. This not only is unbeneficial to the user (or the driver), but also fails to meet the actual use requirements of the attitudes of the user (or the driver) and ergonomics.

There are many other conventional inflatable headrest structures for a user to use in lying and sleeping, they disclose inflation structures for adjusting the fluid amount in the pillow so that the pillow can have different heights in accordance with different requirements of the user in actual use.

It should be noted that such kind of headrest structures for a user to use in lying and sleeping (hereinafter referred to as lying/sleeping pillow for short) cannot be applied to the car seat. The reasons are as follows:
1. The lying/sleeping pillow provides a completely plane face in contact with the head of the user. When the user changes his/her sleeping attitude and the position of the head is changed, the plane face can fully support the head of the user to avoid stiff neck. Therefore, the two lateral sections and/or the lower section of the lying/sleeping pillow is preferably free from any protrusion structure.
2. The conventional lying/sleeping pillow has no structure for truly supporting the cervical vertebrae portion of the user. This is for preventing the head of the user from excessively tilting backward in lying/sleeping so as to avoid snoring.

All the above conditions are not what we expect.

To speak representatively, the conventional car seat headrest has some shortcomings in design of the structure and the application. Also, in practice, some problems exist in the conventional car seat headrest. To overcome the above shortcomings, it is necessary to redesign the assembling structures of the conventional car seat headrest and change the car seat headrest into a different one in accordance with ergonomics. The redesigned car seat headrest has more ideal protection and supporting ability to improve the shortcomings of the conventional car seat headrest.

It is found that the conventional car seat headrest structure has some shortcomings that need to be overcome as follows:
1. The conventional lying/sleeping pillow provides a structural form with a complete (contact) plane face. To overcome this, protrusion structures can be specifically formed on two lateral sections and/or lower section of the headrest. The protrusion structures can be flexibly deformed to elastically adjust the size (or specification) so as to provide true supporting effect.
2. The conventional headrest structure (including the car seat headrest and lying/sleeping pillow) has no structural form that can truly support the cervical vertebrae portion of the user. As a result, the cervical vertebrae portion of the user or the driver always hangs in the air without sufficient support. This will cause that the cervical vertebrae portion of the user (or the driver) feels sore to affect the safety in driving.
3. Especially, the conventional car seat headrest structure is not manufactured according to the different head configurations or the use requirements possibly caused by the actual operation of the user. Therefore, the conventional car seat headrest structure has fixed specification or configuration and can only provide basic supporting effect for the user. As a result, the conventional car seat headrest structure can hardly truly protect or fully support the head and the cervical vertebrae portion of the user. This problem needs to be solved.

All the above issues are not suggested or specifically disclosed in the above reference patents.

### SUMMARY OF THE INVENTION

It is therefore a primary object of the present invention to provide a car seat headrest structure with multipart supporting effect. The car seat headrest structure includes a headrest main body and a support section assembled with the main body. The main body is defined with a middle section, two lateral sections, an upper section and a lower section. The support section includes two lateral support sections positioned on the two lateral sections and a lower support section positioned on the lower section of the main body, whereby the support section is a U-shaped structure. The lower support section and the lateral support sections are flexible protrusion bodies or elastic protrusion structures corresponding to the cervical vertebrae portion and the head of a user. The lateral support sections, the lower support section and the middle section of the main body together define an embracing/supporting section. In accordance with ergonomics, the support sect ion can truly protect and support the head and the cervical vertebrae portion of the user according to the actual use requirements of the user.

Especially, the lower support section corresponds to the cervical vertebrae portion of the user (or the driver). The lower support section can be elastically deformed to compensate the void (or the void range) between the cervical vertebrae portion of the user and the main body so as to truly protect and fully support (the cervical vertebrae portion and/or the head) of the user. The compensation means the support section or the lower support section fills up the void range.

In the above car seat headrest structure with multipart supporting effect, the main body includes a carrier body. The carrier body has a fixed end and a free end. The fixed end is detachably assembled with the main body or integrally secured to the main body, whereby the carrier body (or the free end) can be reciprocally flapped back and forth. The support section is disposed on the carrier body. Alternatively, the carrier body is equipped with a bag body for receiving therein an article or a flexible material. When the carrier body is flapped backward to the other side of the headrest distal from the user and is exposed to the rear side, a common article can be received in the bag body, such as a pair of glasses, a wallet, a kettle, a book, a newspaper, etc. Accordingly, the present invention provides a multifunctional car seat headrest structure.

The present invention can be best understood through the following description and accompanying drawings, wherein:

### BRIEF DESCRIPTION OF THE DRAWINGS

FIG. 1 is a perspective view of the present invention, showing that the main body and the support section are assembled with each other;

FIG. 2 is a perspective view of the application of the present invention according to FIG. 1, showing that the support section helps in protecting and supporting two sides of the head and the cervical vertebrae portion of a user;

FIG. 3 is a sectional view of the present invention according to FIG. 2, showing that the lower support section compensates the void range to help in supporting the head and the cervical vertebrae portion of the user;

FIG. 4 is a perspective view of a modified embodiment of the present invention, showing that the support section is disposed on the carrier body and the carrier body is detachably assembled with the main body or integrally secured to the main body;

FIG. 5 is a perspective view of the modified embodiment of the present invention, showing that the carrier body is flapped backward and exposed to the rear side, whereby an article can be received therein; and

FIG. 6 is a perspective view of a preferred embodiment of the present invention, showing that the support section is connected to an inflation device.

### DETAILED DESCRIPTION OF THE PREFERRED EMBODIMENTS

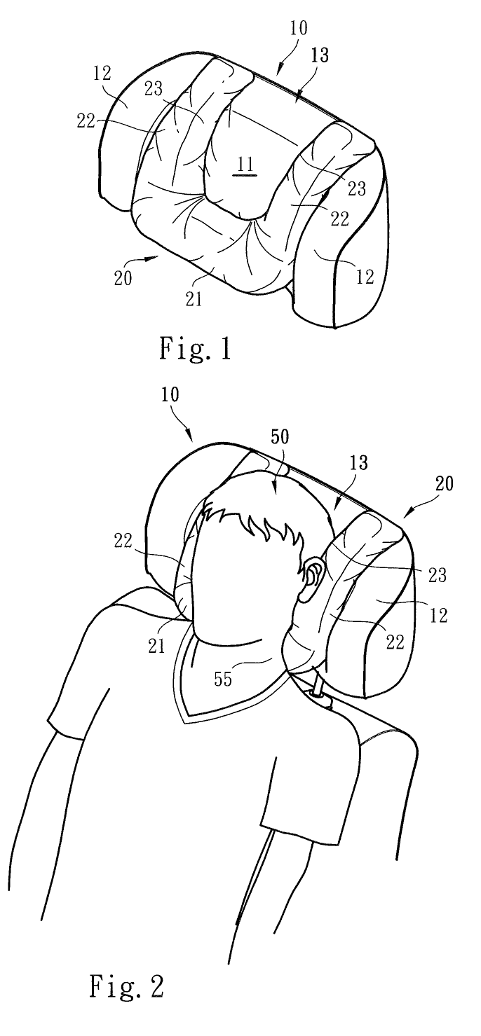

Please refer to FIGS. 1, 2 and 3. The car seat headrest structure with multipart supporting effect of the present invention includes a headrest main body 10 and a support section 20 assembled with the headrest main body 10. The upper section, lower section, two sides and bottom end mentioned hereinafter are referred to with the direction of the drawings as the reference direction. According to the positions of the drawings, the main body 10 is defined with a middle section 11, two lateral sections 12, an upper section 13 and a lower section 14.

In a preferred embodiment, the two lateral sections 12 are bent and laterally extend from the middle section 11 of the main body 10, whereby the two lateral sections 12 form arched protrusion structures (relative to the middle section 11). Accordingly, each lateral section 12 and the middle section 11 contain a bending angle, whereby the two lateral sections 12 can embrace, protect and support two sides of a user's head 20.

The support section 20 includes two lateral support sections 22 positioned on the two lateral sections 12 of the main body 10 and a lower support section 21 positioned on the lower section 14 of the main body 10. Accordingly, the support section 20 is a U-shaped structure. The lower support section 21 and the lateral support sections 22 are flexible protrusion bodies or elastic protrusion structures corresponding to the cervical vertebrae portion 55 and the two sides of the head 50 of the user. Each lateral support section 22 has a contact face 23. The contact face 23 can be a plane face or an arched face contacting and supporting the two sides of the head 50 of the user. The lower support section 21 and the lateral support sections 22 cooperate with the middle section 11 of the main body 10 to together form an embracing/supporting section or (support) space. In accordance with the ergonomics, the support section 20 can provide a multipart supporting system to protect and support the cervical vertebrae portion 55 and the head 50 of a user as the actual use requirements of the user.

To speak more specifically, corresponding to the head 50 and the cervical vertebrae portion 55 of a user, the lower support section 21 of the support section 20 extends along the lower section 14 of the main body 10. The lateral support sections 22 extend along the lateral sections 12 of the main body 10 from the lower section 14 to the upper section 13. The contact faces 23 are disposed on the lateral support sections 22 (facing the head 50 of the user). Accordingly, the contact faces 23 of the lateral support sections 22 respectively positioned on the two lateral sections 12 are opposite to each other (facing each other).

It should be noted that the support section 20 or the filling material filled therein can be selectively a flexible or elastic material such as a fluid, animal furs, fibers, cotton, foam rubber, soft (silicone) gum or the like material. Accordingly, the hardness of the support section 20 is smaller than the hardness of the main body 10. In this case, the support section 20 can be (elastically) deformed to different extents within different ranges according to the different head configurations and/or actual use requirements of the user (the driver). Under such circumstance, the support section 20 can comfortably embrace and truly protect and support the head 50 and the cervical vertebrae portion 55 of the user. This improves the shortcoming of the conventional harder headrest structure that the headrest can only provide supporting effect for a user's head.

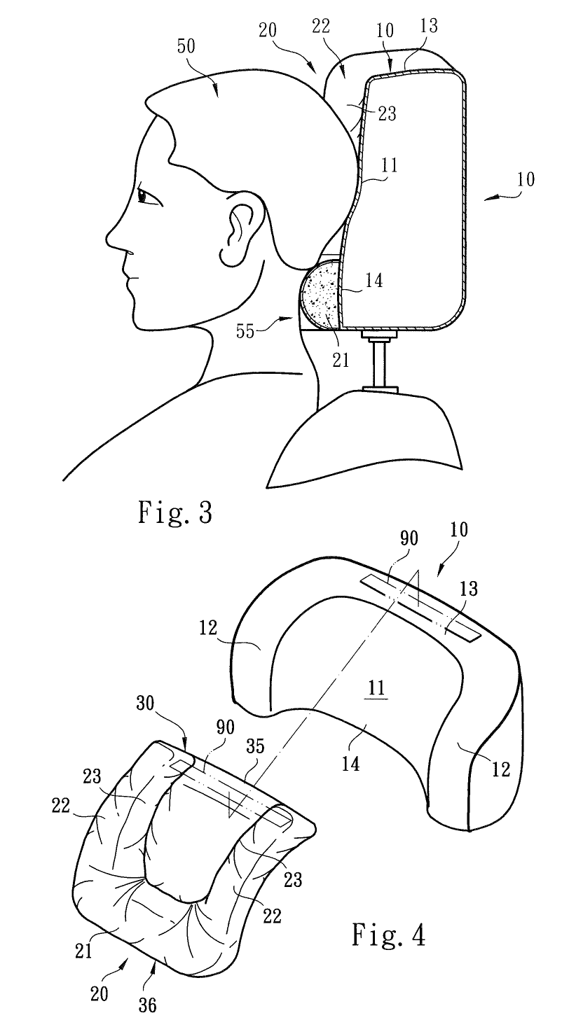

For example, as shown in FIGS. 2 and 3, according to the size of the void (or the void range) between the cervical vertebrae portion 55 of the user and the main body 10, the support section 20 (or the lower support section 21) is elastically deformed to compensate the void. In this case, the support section 20 can truly protect and fully support (the cervical vertebrae portion 55 and/or the head 50 of) the user.

The compensation means the support section 20 (or the lower support section 21) fills up the void range. In contrast, the conventional headrest structure has the shortcoming that the cervical vertebrae portion of the user (the driver) hangs in the air without sufficient support. This fails to meet ergonomics. As a result, after a long period of driving, the cervical vertebrae portion of the user will feel sore to affect the safety in driving. The present invention obviously improves the shortcoming of the conventional headrest structure.

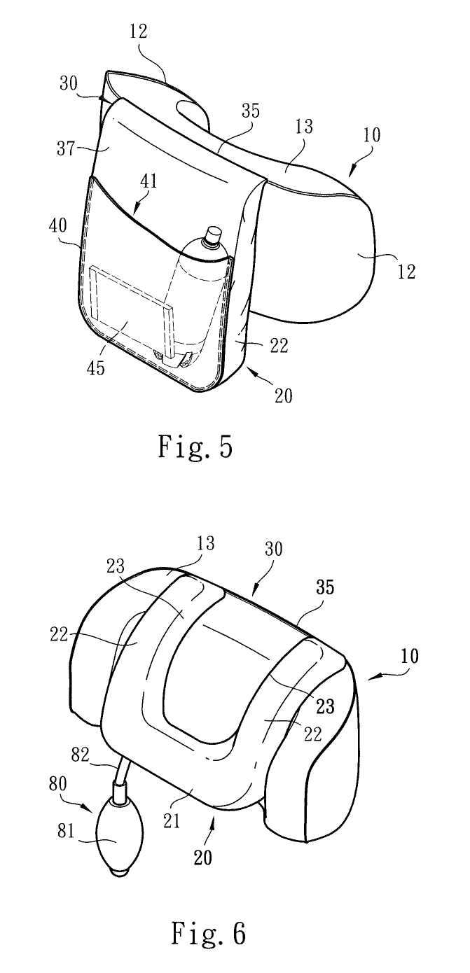

Please now refer to FIGS. 4 and 5. In a modified embodiment, a carrier body 30 is integrally disposed on or detachably assembled with the main body 10 (or the upper section 13). The carrier body 30 is made of flexible material and has the form of a thin and flat structure. The upper section of the carrier body 30 has a fixed end 35, while the lower section of the carrier body 30 has a free end 36. Accordingly, the carrier body 30 (and/or the free end 36) can be reciprocally flapped back and forth.

In a preferred embodiment, an envelope (not shown) can be disposed at the fixed end 35 of the carrier body 30 for enveloping the main body 10. Alternatively, the fixed end 35 is detachably assembled with the main body 10 by means of hook-and-loop fasteners 90 or the like. Alternatively, the fixed end 35 is integrally formed and secured to the main body 10 (or the upper section 13).

In this embodiment, the back face 37 of the carrier body 30 is equipped with a bag body 40 having an opening 41. An article 45 or a flexible material 60 can be received in the bag body 40.

To speak more specifically, when the carrier body 30 is operated to face the user (the headrest or the main body 10), according to the different head configurations or actual use requirements of the user (the driver), a flexible material can be selectively received or filled in the bag body 40, whereby the bag body 40 has different heights or thicknesses for supporting the head 50 of the user. In contrast, the conventional car seat headrest structure has fixed specification or configuration and can only provide basic supporting effect for the user. As a result, the conventional car seat headrest structure can hardly truly protect or fully support the head and the cervical vertebrae portion of the user. The present invention improves this shortcoming of the conventional headrest structure.

When the carrier body 30 is flapped backward to the other side of the headrest or the main body 10 distal from the user and is exposed to the rear side as shown in FIG. 5, a common article 45 can be received in the bag body 40, such as a pair of glasses, a wallet, a kettle, a book, a newspaper, etc. Accordingly, the present invention provides a multifunctional car seat headrest structure. Please now refer to FIG. 6. In a preferred embodiment, the support section 20 is connected to an inflation device 80. The inflation device 80 has a pump 81 and an air hose 82 connected with the pump 81. The air hose 82 is connected with the support section 20 or the lower support section 21. By means of operating the pump 81, a fluid is controlled to enter the support section 20 to elastically adjust the size or specification of the support section 20. In this case, in accordance with ergonomics, the support section 20 can truly protect and support the head 50 and the cervical vertebrae portion 55 of the user according to the different head configurations and/or actual use requirements of the user (the driver).

To speak representatively, in comparison with the conventional car seat headrest structure, the car seat headrest structure with multipart supporting effect of the present invention has the following advantages:
1. The structural forms of the main body 10 and the support section 20 or the carrier body 30 assembled with the main body 10 have been redesigned. For example, the main body 10 has two lateral sections 12 in the form of protrusion structures. The lower support section 21 of the support section 20 extends along the lower section 14 of the main body 10. The lateral support sections 22 extend along the lateral sections 12 of the main body 10 from the lower section 14 to the upper section 13. The lower support section 21 is connected between the lateral support sections 22. The carrier body 30 and the support section 20 are disposed on the main body 10 and can be reciprocally flapped back and forth. The back face 37 of the carrier body 30 is equipped with a bag body 40 for receiving therein an article 45. This is obviously different from the structural form of the conventional car seat headrest structure.
2. The conventional lying/sleeping pillow provides a structural form with a complete (contact) plane face. In contrast, in the present invention, the main body 10 is assembled with the support section 20 (and/or the carrier body 30) to provide a lower support section 21 and two lateral support sections 22 on the lower section 14 and/or the two lateral sections 12 of the main body 10, which together form an elastic protrusion structure. The size or specification of the protrusion structure can be elastically adjusted according to the different head configurations or actual use requirements of the driver so as to truly protect and support the head 50 and the cervical vertebrae portion 55 of the driver.
3. Especially, the main body 10 is connected with the support section 20 (or the main body 10 is equipped with the carrier body 40) to provide a flexibly deformable structural form. This can enhance the comfortableness of the user in use of the headrest structure. In contrast, the conventional car seat headrest structure is not manufactured according to the different head configurations or actual use requirements of the user and the conventional car seat headrest structure has fixed specification or configuration and can only provide basic supporting effect for the user. As a result, the conventional car seat headrest structure can hardly truly protect or fully support the head and the cervical vertebrae portion of the user. The present invention improves this shortcoming of the conventional car seat headrest structure. In addition, a flexible material can be received or filled in the bag body 40 according to the different head configurations or the use requirements possibly caused by the actual operation of the user, whereby the bag body 40 and/or the carrier body 30 can have different heights or thicknesses for supporting the head 50 of the user. Alternatively, when the carrier body 30 is flapped backward to the other side of the headrest or the main body 10 distal from the user, a common article 45 can be received in the bag body 40. Accordingly, the present invention provides a multifunctional car seat headrest structure.

In conclusion, the car seat headrest structure with multipart supporting effect of the present invention is effective and different from the conventional car seat headrest structure in space form. The car seat headrest structure with multipart supporting effect of the present invention is inventive, greatly advanced and advantageous over the conventional car seat headrest structure.

The above embodiments are only used to illustrate the present invention, not intended to limit the scope thereof. Many modifications of the above embodiments can be made without departing from the spirit of the present invention.

What is claimed is:

1. A car seat headrest structure with multipart supporting effect, comprising a main body and a support section assembled on the main body, the main body being defined with a middle section, two lateral sections, an upper section and a lower section, the support section having a lower support section positioned on the lower section of the main body and two lateral support sections positioned on the two lateral sections of the main body, whereby the support section is a U-shaped structure, the lower support section and the lateral support sections being flexible protrusion structures, the lateral support sections, the lower support section and the middle section of the main body together defining an embracing/supporting section.

2. The car seat headrest structure with multipart supporting effect as claimed in claim 1, wherein the two lateral sections are bent and laterally extend from the middle section of the main body, whereby the two lateral sections form arched protrusion structures so that each lateral section and the middle section contain a bending angle.

3. The car seat headrest structure with multipart supporting effect as claimed in claim 1, wherein each lateral support section has a contact face, the contact face being a plane face or an arched face, the lateral support sections of the support section respectively extending along the two lateral sections of the main body from the lower section to the upper section, the lower support section being connected between the lateral support sections, the contact faces of the lateral support sections respectively positioned on the two lateral sections being opposite to each other.

4. The car seat headrest structure with multipart supporting effect as claimed in claim 2, wherein each lateral support section has a contact face, the contact face being a plane face or an arched face, the lateral support sections of the support section respectively extending along the two lateral sections of the main body from the lower section to the upper section, the lower support section being connected between the lateral support sections, the contact faces of the lateral support sections respectively positioned on the two lateral sections being opposite to each other.

5. The car seat headrest structure with multipart supporting effect as claimed in claim 1, wherein a hardness of the support section is smaller than a hardness of the main body, whereby the support section is flexibly deformable.

6. The car seat headrest structure with multipart supporting effect as claimed in claim 2, wherein a hardness of the support section is smaller than a hardness of the main body, whereby the support section is flexibly deformable.

7. The car seat headrest structure with multipart supporting effect as claimed in claim 3, wherein a hardness of the support section is smaller than a hardness of the main body, whereby the support section is flexibly deformable.

8. The car seat headrest structure with multipart supporting effect as claimed in claim 4, wherein a hardness of the support section is smaller than a hardness of the main body, whereby the support section is flexibly deformable.

9. The car seat headrest structure with multipart supporting effect as claimed in claim 1, wherein the support section is connected to an inflation device, the inflation device having a pump and an air hose connected with the pump, the air hose being connected with the support section.

10. The car seat headrest structure with multipart supporting effect as claimed in claim 2, wherein the support section is connected to an inflation device, the inflation device having a pump and an air hose connected with the pump, the air hose being connected with the support section.

11. The car seat headrest structure with multipart supporting effect as claimed in claim 3, wherein the support section is connected to an inflation device, the inflation device having a pump and an air hose connected with the pump, the air hose being connected with the support section.

12. The car seat headrest structure with multipart supporting effect as claimed in claim 4, wherein the support section is connected to an inflation device, the inflation device having a pump and an air hose connected with the pump, the air hose being connected with the support section.

13. The car seat headrest structure with multipart supporting effect as claimed in claim 5, wherein the support section is connected to an inflation device, the inflation device having a pump and an air hose connected with the pump, the air hose being connected with the support section.

14. The car seat headrest structure with multipart supporting effect as claimed in claim 6, wherein the support section is connected to an inflation device, the inflation device having a pump and an air hose connected with the pump, the air hose being connected with the support section.

15. The car seat headrest structure with multipart supporting effect as claimed in claim 7, wherein the support section is connected to an inflation device, the inflation device having a pump and an air hose connected with the pump, the air hose being connected with the support section.

16. The car seat headrest structure with multipart supporting effect as claimed in claim 8, wherein the support section is connected to an inflation device, the inflation device having a pump and an air hose connected with the pump, the air hose being connected with the support section.

17. A car seat headrest structure with multipart supporting effect, comprising:
a main body defined with a middle section, two lateral sections, an upper section and a lower section;
a carrier body disposed on the main body, the carrier body being integrally fixedly disposed on the main body or detachably assembled with the main body, the carrier body being made of flexible material in the form of a thin and flat structure, whereby the carrier body can be reciprocally flapped back and forth; and
a support section disposed on the main body, the support section having a lower support section positioned on a lower section of the carrier body and two lateral support sections positioned on two lateral sections of the carrier body, whereby the support section is a U-shaped structure, the lower support section and the lateral support sections being flexible protrusion structures, the lateral support sections, the lower support section and the middle section of the main body together defining an embracing/supporting section.

18. The car seat headrest structure with multipart supporting effect as claimed in claim 17, wherein the two lateral sections are bent and laterally extend from the middle section of the main body, whereby the two lateral sections form arched protrusion structures so that each lateral section and the middle section contain a bending angle.

19. The car seat headrest structure with multipart supporting effect as claimed in claim 17, wherein each lateral support section has a contact face, the contact face being a plane face or an arched face, an upper section of the carrier body having a fixed end, while the lower section of the carrier body having a free end, a fastener being disposed at the fixed end of the carrier body, whereby the carrier body is detachably assembled with the main body.

20. The car seat headrest structure with multipart supporting effect as claimed in claim 18, wherein each lateral support section has a contact face, the contact face being a plane face or an arched face, an upper section of the carrier body having a fixed end, while the lower section of the carrier body having a free end, a fastener being disposed at the fixed end of the carrier body, whereby the carrier body is detachably assembled with the main body.

21. The car seat headrest structure with multipart supporting effect as claimed in claim 17, wherein a hardness of the support section is smaller than a hardness of the main body, whereby the support section is flexibly deformable.

22. The car seat headrest structure with multipart supporting effect as claimed in claim 18, wherein a hardness of the support section is smaller than a hardness of the main body, whereby the support section is flexibly deformable.

23. The car seat headrest structure with multipart supporting effect as claimed in claim 19, wherein a hardness of the support section is smaller than a hardness of the main body, whereby the support section is flexibly deformable.

24. The car seat headrest structure with multipart supporting effect as claimed in claim 20, wherein a hardness of the support section is smaller than a hardness of the main body, whereby the support section is flexibly deformable.

25. The car seat headrest structure with multipart supporting effect as claimed in claim 17, wherein a back face of the carrier body is equipped with a bag body, the bag body having an opening.

26. The car seat headrest structure with multipart supporting effect as claimed in claim 18, wherein a back face of the carrier body is equipped with a bag body, the bag body having an opening.

27. The car seat headrest structure with multipart supporting effect as claimed in claim 19, wherein a back face of the carrier body is equipped with a bag body, the bag body having an opening.

28. The car seat headrest structure with multipart supporting effect as claimed in claim 20, wherein a back face of the carrier body is equipped with a bag body, the bag body having an opening.

29. The car seat headrest structure with multipart supporting effect as claimed in claim 21, wherein a back face of the carrier body is equipped with a bag body, the bag body having an opening.

30. The car seat headrest structure with multipart supporting effect as claimed in claim 22, wherein a back face of the carrier body is equipped with a bag body, the bag body having an opening.

31. The car seat headrest structure with multipart supporting effect as claimed in claim 23, wherein a back face of the carrier body is equipped with a bag body, the bag body having an opening.

32. The car seat headrest structure with multipart supporting effect as claimed in claim 24, wherein a back face of the carrier body is equipped with a bag body, the bag body having an opening.

33. The car seat headrest structure with multipart supporting effect as claimed in claim 17, wherein the support section is connected to an inflation device, the inflation device having a pump and an air hose connected with the pump, the air hose being connected with the support section.

34. The car seat headrest structure with multipart supporting effect as claimed in claim 18, wherein the support section is connected to an inflation device, the inflation device having a pump and an air hose connected with the pump, the air hose being connected with the support section.

35. The car seat headrest structure with multipart supporting effect as claimed in claim 19, wherein the support section is connected to an inflation device, the inflation device having a pump and an air hose connected with the pump, the air hose being connected with the support section.

36. The car seat headrest structure with multipart supporting effect as claimed in claim 20, wherein the support section is connected to an inflation device, the inflation device having a pump and an air hose connected with the pump, the air hose being connected with the support section.

37. The car seat headrest structure with multipart supporting effect as claimed in claim 21, wherein the support section is connected to an inflation device, the inflation device having a pump and an air hose connected with the pump, the air hose being connected with the support section.

38. The car seat headrest structure with multipart supporting effect as claimed in claim 22, wherein the support section is connected to an inflation device, the inflation device having a pump and an air hose connected with the pump, the air hose being connected with the support section.

39. The car seat headrest structure with multipart supporting effect as claimed in claim 23, wherein the support section is connected to an inflation device, the inflation device having a pump and an air hose connected with the pump, the air hose being connected with the support section.

40. The car seat headrest structure with multipart supporting effect as claimed in claim 24, wherein the support section is connected to an inflation device, the inflation device having a pump and an air hose connected with the pump, the air hose being connected with the support section.

41. The car seat headrest structure with multipart supporting effect as claimed in claim 25, wherein the support section is connected to an inflation device, the inflation device having a pump and an air hose connected with the pump, the air hose being connected with the support section.

42. The car seat headrest structure with multipart supporting effect as claimed in claim 26, wherein the support section is connected to an inflation device, the inflation device having a pump and an air hose connected with the pump, the air hose being connected with the support section.

43. The car seat headrest structure with multipart supporting effect as claimed in claim 27, wherein the support section is connected to an inflation device, the inflation device having a pump and an air hose connected with the pump, the air hose being connected with the support section.

44. The car seat headrest structure with multipart supporting effect as claimed in claim 28, wherein the support section is connected to an inflation device, the inflation device having a pump and an air hose connected with the pump, the air hose being connected with the support section.

45. The car seat headrest structure with multipart supporting effect as claimed in claim 29, wherein the support section is connected to an inflation device, the inflation device having a pump and an air hose connected with the pump, the air hose being connected with the support section.

46. The car seat headrest structure with multipart supporting effect as claimed in claim 30, wherein the support section is connected to an inflation device, the inflation device having a pump and an air hose connected with the pump, the air hose being connected with the support section.

47. The car seat headrest structure with multipart supporting effect as claimed in claim 31, wherein the support section is connected to an inflation device, the inflation device having a pump and an air hose connected with the pump, the air hose being connected with the support section.

48. The car seat headrest structure with multipart supporting effect as claimed in claim 32, wherein the support section is connected to an inflation device, the inflation device having a pump and an air hose connected with the pump, the air hose being connected with the support section.
